(19) United States
(12) Patent Application Publication
(10) Pub. No.: US 2014/0015920 A1
(43) Pub. Date: Jan. 16, 2014

(54) VIRTUAL PERSPECTIVE IMAGE SYNTHESIZING SYSTEM AND ITS SYNTHESIZING METHOD

(71) Applicant: VIVOTEK INC., New Taipei (TW)

(72) Inventor: Jen-Chih Wu, New Taipei (TW)

(21) Appl. No.: 13/938,665

(22) Filed: Jul. 10, 2013

(30) Foreign Application Priority Data
Jul. 13, 2012 (TW) 101125415

(51) Int. Cl. H04N 5/232

(52) U.S. Cl. CPC H04N 5/23238
USPC 348/38

(57) ABSTRACT

The present disclosure provides a virtual perspective image synthesizing system for synthesizing multiple planar images into a virtual perspective image. The planar images are of the same object, as photographed by various panoramic camera devices, for example, fisheye lens and multi-lens camera devices. The virtual perspective image synthesizing system includes a computing device and a plurality of panoramic camera devices. The panoramic camera devices are arranged throughout the space to be monitored. The computing device is electrically connected to the panoramic camera devices. The computing device selects at least two of the panoramic camera devices based on the viewing position the viewer wishes to view from and distance of each panoramic camera device to the viewing target. The computing device synthesizes according to the synthesizing angle the panoramic images selected, to generate the virtual perspective image.

### CROSS-REFERENCE TO RELATED APPLICATIONS

This non-provisional application claims priority under 35 U.S.C. §119(a) on Patent Application No(s). 101125415 filed in Taiwan, R.O.C. on Jul. 13, 2012, the entire contents of which are hereby incorporated by reference.

### BACKGROUND OF THE INVENTION

1. Technical Field

The present disclosure relates to a digital image processing system and method, especially a virtual perspective image synthesizing system and its synthesizing method.

2. Related Art

As the availability of monitoring devices increase, more and more people are installing monitoring devices to protect their safety and their property. To achieve complete monitoring coverage, panoramic camera devices have been proposed. Panoramic camera devices can be realized by incorporating multiple lenses or by one fisheye lens. The advantage of panoramic camera devices lies in its complete monitoring coverage, allowing the digital photographed image to be viewed without any gap in coverage.

Although panoramic camera devices exhibit the above mentioned advantages, the digital images produced by the panoramic camera devices are still only two-dimensional planar images. Therefore the viewer can only view the planar images from the photographing location of the physical panoramic camera device that photographed the image. If the viewer wished to view the image from another angle, the viewer would have to do so through another camera device located at a different location. However, if there is no camera device located at the location the viewer wished to view from, then it is not possible to view from that particular angle. The known virtual view synthesizing technique can synthesize original images taken from various angles to generate a virtual view image. However, the traditional method utilizes non-panoramic camera devices, so the viewer needs to readjust the angle of the camera device to face towards the direction the viewer wished to view, making the process more troublesome.

### SUMMARY

In response to the above mentioned inconveniencies, this disclosure provides a virtual perspective image synthesizing system that can synthesize planar images to a virtual view image of any angle.

The present disclosure provides a virtual perspective image synthesizing system including a computing device and a plurality of panoramic camera devices. Each panoramic camera device is configured to photograph a planar image, and the planar image could be a panoramic image. The panoramic camera devices are arranged throughout the space to be monitored, at a fixed distance apart from each other. The computing device is electrically connected to the panoramic camera devices. The viewer inputs through the inputting interface of the computing device the viewing position the viewer wishes to view from and the viewing target position. The computing device then selects at least two of the panoramic camera devices based on the viewing position the viewer wishes to view from and distance of each panoramic camera device to the viewing target. And then, the computing device determines a synthesizing angle for each panoramic camera device selected, according to the viewing target and the viewing position of the viewer. The computing device synthesizes the panoramic images selected, according to the synthesizing angle, to generate the virtual perspective image.

The present disclosure provides a virtual perspective image synthesizing method including the following steps: activating at least two of the panoramic camera devices to photograph planar images, and one of the planar image could be a panoramic image; selecting at least two of the panoramic camera devices according to the viewing position the viewer wishes to view from and distance of each panoramic camera device to a viewing target; and synthesizing a virtual perspective image based on the multiple planar images photographed by the selected panoramic camera devices.

The present disclosure selects at least two panoramic camera devices of all of the panoramic camera devices to photograph panoramic images from different angles. The panoramic images photographed from different angles are then synthesized to generate the virtual perspective image.

### BRIEF DESCRIPTION OF THE DRAWINGS

The present disclosure will become more fully understood from the detailed description given herein below for illustration only, and thus does not limit the present disclosure, wherein:

FIG. 1 shows a system block diagram of a virtual perspective image synthesizing system according to the present disclosure.

FIG. 2A shows a process flowchart of a real time synthesizing method according to the present disclosure.

FIG. 2B shows a process flowchart of a general synthesizing method according to the present disclosure.

FIG. 3 illustrates an arrangement of panoramic camera devices according to the present disclosure.

FIG. 4A illustrates panoramic camera devices photographing a target object from different angles according to the present disclosure.

FIG. 4B-1 illustrates a target object, as photographed by a panoramic camera device according to the present disclosure.

FIG. 4B-2 illustrates the target object, as photographed by another panoramic camera device according to the present disclosure.

FIG. 4C illustrates a virtual perspective image synthesized according to the present disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

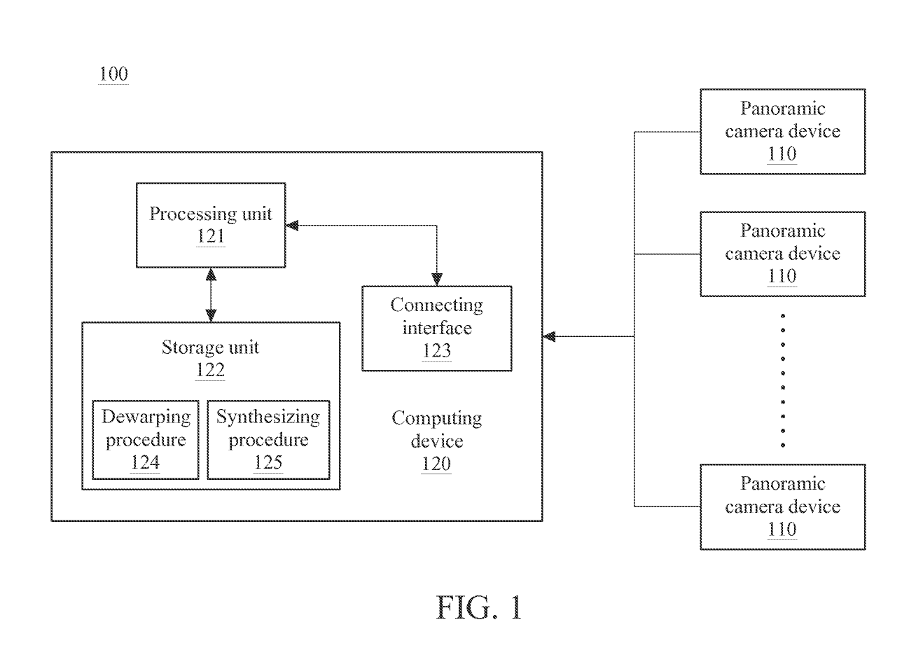

The virtual perspective image synthesizing system of the present disclosure can be applied to road monitoring, home surveillance, or security systems. Please refer to FIG. 1, a system block diagram of the virtual perspective image synthesizing system. The virtual perspective image synthesizing system 100 includes a plurality of panoramic camera devices 110 and a computing device 120. According to the space available, for example, indoors with a ceiling, indoors with walls, outdoors or open space, the panoramic camera devices are disposed as a two-dimensional grid, and the adjacent panoramic camera devices are separated by a fixed distance. The panoramic camera devices 110 of the present disclosure are camera devices that can photograph panoramically, for example, fisheye camera devices or multi-lens camera devices. Therefore, the viewer can install the panoramic camera devices 110 on the ceiling, floor, or walls to view images in every direction of the space of concern.

The computing device 120 includes a processing unit 121, a storage unit 122, and a connecting interface 123 of camera device. Generally speaking, the computing device 120 can be realized through a personal computer, a laptop computer, or a digital video recorder. The processing unit 121 is electrically connected to the storage unit 122 and the connecting interface 123. Aside from recording the digital images photographed by the panoramic camera devices 110, the storage unit 122 also stores a dewarping procedure 124 and a synthesizing procedure 125. The computing device 120 can be connected to each panoramic camera device 110 through a connecting interface 123 by a physical cable or wireless connection. The computing device 120 receives planar images, such as panoramic images 410, photographed by the panoramic camera devices 110. The panoramic images 410 can be photo images or motion pictures. The viewing angle and viewing position of the panoramic images 410 of the present disclosure can be chosen by the viewer.

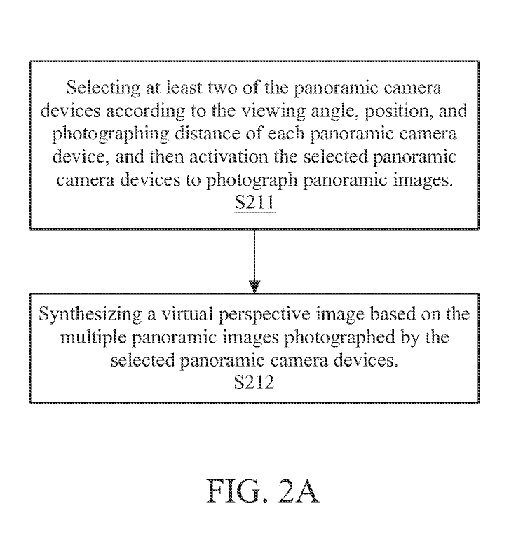

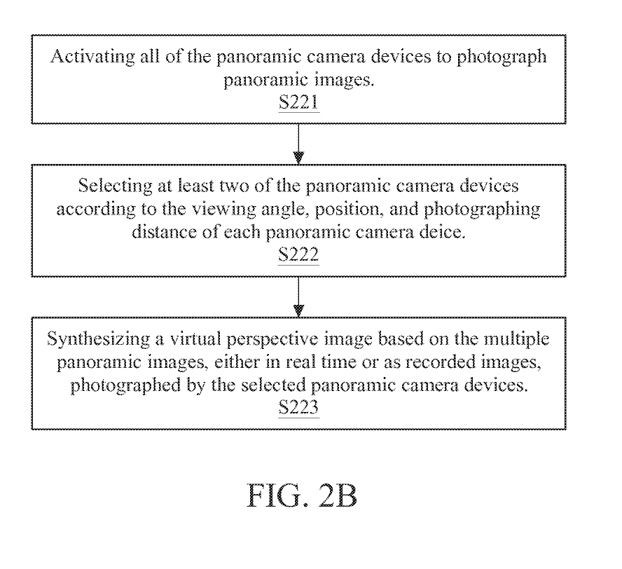

And then, the processing unit 121 performs the synthesizing procedure 125 on the panoramic images 410. The present disclosure provides two synthesizing methods, real time synthesizing method and general synthesizing method. Please refer to FIG. 2A and FIG. 2B, the process flowchart of the operation of the real time synthesizing and general synthesizing, for the following explanation of the image synthesizing process.

The determining and processing procedures of the real time synthesizing method of the present disclosure include the following steps:
Step S211: selecting at least two of the panoramic camera devices according to the viewing position the viewer wishes to view from and distance of each panoramic camera device to the viewing target, and then activating the selected panoramic camera devices to photograph panoramic images
Step S212: synthesizing a virtual perspective image based on the multiple panoramic images photographed by the selected panoramic camera devices The determining and processing procedures of the general synthesizing method of the present disclosure include the following steps:
Step S221: activating all of the panoramic camera devices to photograph panoramic images
Step S222: selecting at least two of the panoramic camera devices according to the viewing position the viewer wishes to view from and distance of each panoramic camera device to the viewing target
Step S223: synthesizing a virtual perspective image based on the multiple panoramic images, either in real time or as recorded images, photographed by the selected panoramic camera devices

First, the viewer inputs through the inputting interface of the computing device the position and viewing direction the viewer wishes to view from. Then a desired target object position is selected from the viewer's input. After the target object position is selected, the computing device 120 determines the distance and viewing angle from each panoramic camera device 110 to the target object, according to the target object position.

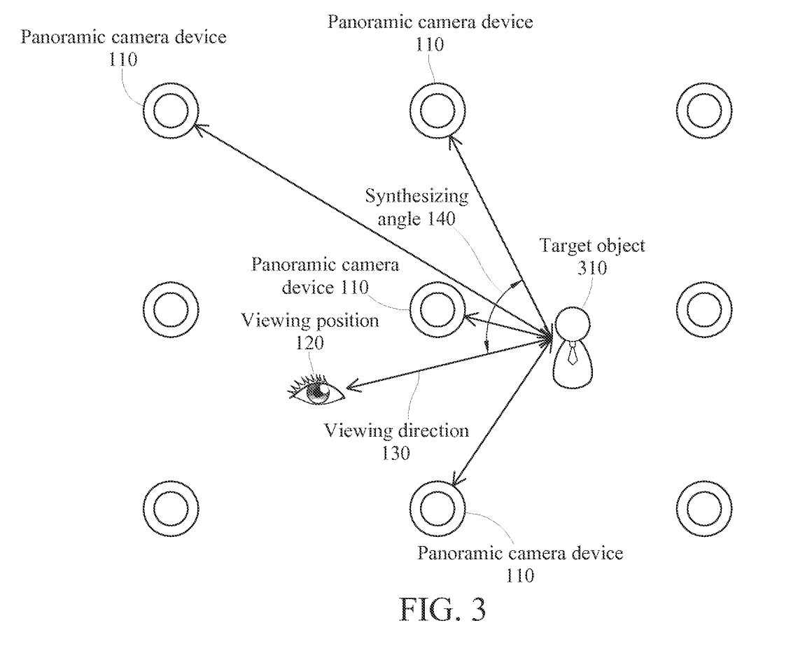

The computing device 120 can select at least two panoramic camera devices 110 from all of the panoramic camera devices 110. The selection can be made based on the viewing position the viewer wishes to view from and distance of each panoramic camera device 110 to the viewing target. And then, the computing device determines a synthesizing angle for each panoramic camera device 110 selected, according to the viewing target and the viewing position of the viewer. Please refer to FIG. 3, an illustration of the photographing positions of the present disclosure. All of the panoramic camera devices 110 illustrated in FIG. 3 are able to photograph a target object 310. To emphasize the panoramic camera devices 110 selected, the panoramic camera devices 110 selected and the target object 310 are linked by lines with black arrows at both ends. A synthesizing angle 140 for each panoramic camera devices 110 selected is determined according to the viewing target 310 and the viewing position 120 of the viewer. Note also that the synthesizing angle 140 can also be determined by the viewing direction 130 instead of the viewing position 120. The panoramic images 410 photographed by the panoramic camera devices 110 can contain distortion. In this case, it is necessary to put the panoramic images 410 through the dewarping procedure 124 to obtain planar panoramic images correlated to the panoramic images 410. Planar panoramic image (planar images) refers to the dewarped image. If the panoramic images 410 do not contain distortion, then the dewarping procedure 124 is not necessary.

The computing device 120 performs the synthesizing procedure 125 after receiving the planar panoramic images 410 photographed by the panoramic camera devices 110. The synthesizing procedure 125 performs calculation algorithms (for example, interpolation) on the planar panoramic images 410 of various photographing angles.

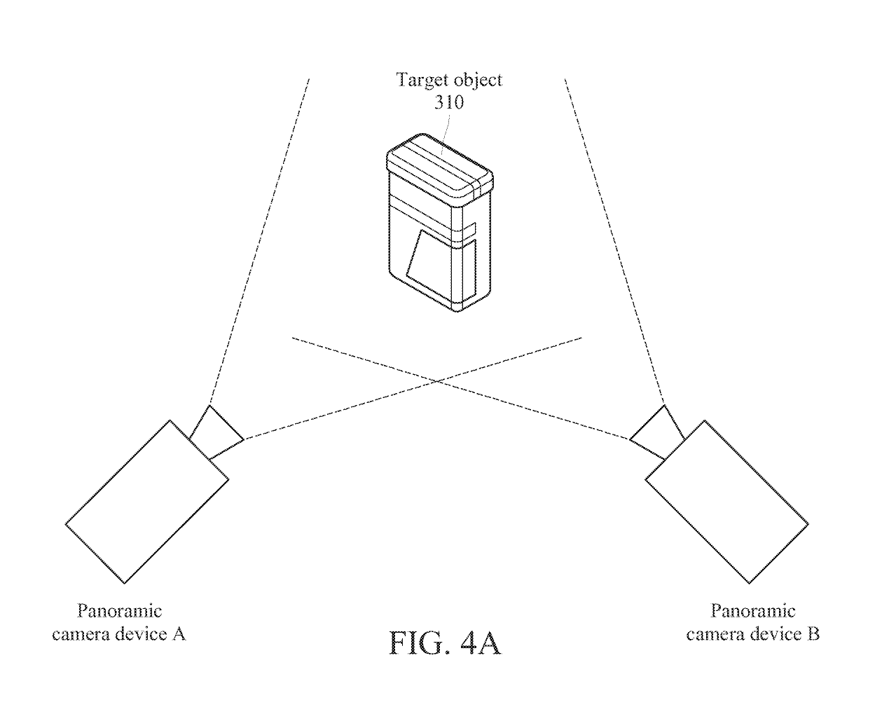

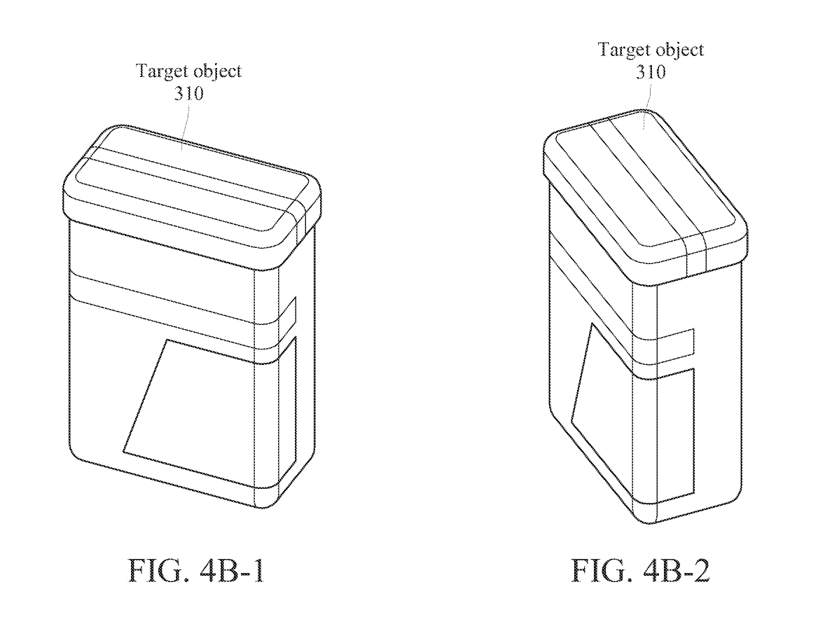

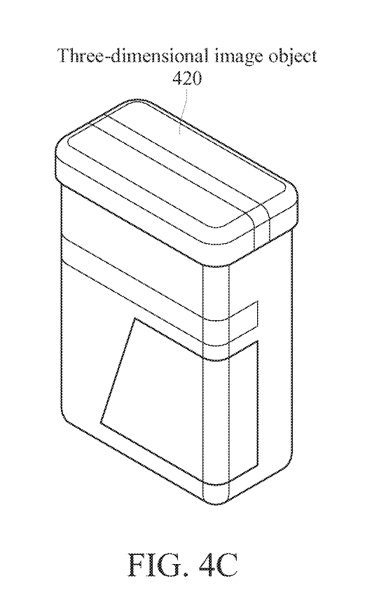

Please refer to FIG. 4A, FIG. 4B-1, FIG. 4B-2, and FIG. 4C for the following explanation regarding the synthesized virtual perspective image of the present disclosure. The box pictured in FIG. 4A, for example, is photographed by a panoramic camera device A and a panoramic camera device B from different photographing angles. FIG. 4B-1 illustrates the target object 310 photographed by the panoramic camera device A. Similarly, FIG. 4B-2 illustrates the target object 310 photographed by the panoramic camera device B. The synthesizing procedure 125 performs known algorithms (for example, interpolation, as mentioned above) to calculate the appearance of the synthesized panoramic images 410.

Finally, the computing device 120 generates synthetic virtual perspective images and a correlating three-dimensional image object 420 according to the panoramic images 410 in FIG. 4B-1 and FIG. 4B-2 of different photographing angles. Due to the limited angle photographed by the panoramic camera device A and panoramic camera device B, the rotatable angle of the synthesized three-dimensional image object 420 is based upon the photographing angle of the panoramic camera device A and panoramic camera device B.

The present disclosure selects at least two panoramic camera devices 110 of all of the panoramic camera devices 110 to photograph panoramic images 410 from different angles. The panoramic images 410 photographed from different angles then become synthesized to generate the correlating three-dimensional image object 420.

What is claimed is:

1. A virtual perspective image synthesizing system, for synthesizing multiple planar images into a virtual perspective image, the virtual perspective image synthesizing system comprising:
a plurality of panoramic camera devices, each panoramic camera device being configured to photograph a panoramic image; and
a computing device, electrically connected to the panoramic camera devices, for selecting at least two of the panoramic camera devices based on the viewing position the viewer wishes to view from and distance of each panoramic camera device to the viewing target;
wherein the computing device determines a synthesizing angle for each selected panoramic camera devices according to the viewing target and the viewing position of the viewer, and synthesizes according to the synthesizing angle the panoramic images photographed by the selected panoramic camera devices for generating the virtual perspective image.

2. The virtual perspective image synthesizing system according to claim 1, wherein at least one of the panoramic camera devices is a fisheye camera device or a multi-lens camera device.

3. The virtual perspective image synthesizing system according to claim 1, wherein the panoramic camera devices are disposed as a two-dimensional grid, and the adjacent panoramic camera devices are separated by a fixed distance.

4. The virtual perspective image synthesizing system according to claim 3, wherein the panoramic camera devices are used for security surveillance.

5. The virtual perspective image synthesizing system according to claim 1, wherein the computing device performs a dewarping process on the panoramic image to generate a planar image of the panoramic image.

6. A virtual perspective image synthesizing method, for use in a virtual perspective image synthesizing system comprising of a plurality of panoramic camera devices, synthesizing multiple planar images into a virtual perspective image, the virtual perspective image synthesizing method comprising:
activating at least two of the panoramic camera devices, each panoramic camera device being configured to photograph a panoramic image;
selecting at least two of the panoramic camera devices based on the viewing position the viewer wishes to view from and distance of each panoramic camera device to the viewing target;
synthesizing the panoramic images photographed by the panoramic camera devices selected to produce a virtual perspective image.

7. The virtual perspective image synthesizing method according to claim 6, wherein at least one of the panoramic camera devices is a fisheye camera device or a multi-lens camera device.

8. The virtual perspective image synthesizing method according to claim 6, wherein the panoramic camera devices are disposed as a two-dimensional grid, and the adjacent panoramic camera devices are separated by a fixed distance.

9. The virtual perspective image synthesizing method according to claim 8, wherein the panoramic camera devices are used for security surveillance.

10. The virtual perspective image synthesizing method according to claim 6, wherein the computing device performs a dewarping process on the panoramic images to generate a planar image of the panoramic images.
